(19) United States
(12) Patent Application Publication
(10) Pub. No.: US 2024/0303034 A1
(43) Pub. Date: Sep. 12, 2024

(54) Apparatus and method for rendering audio content as part of an interactive digital service

(71) Applicant: ORANGE, ISSY LES MOULINEAUX (FR)

(72) Inventors: Chantal Guionnet, Chatillon Cedex (FR); Sylvie Le Gac Cesbron, Chatillon Cedex (FR); Sébastien Chevallier, Chatillon Cedex (FR)

(21) Appl. No.: 18/564,891

(22) PCT Filed: May 30, 2022
(86) PCT No.: PCT/FR2022/051008

§ 371 Date: Nov. 28, 2023

(30) Foreign Application Priority Data
May 31, 2021 (FR) FR2105688

(51) Int. Cl. G06F 3/16

(52) U.S. Cl. CPC G06F 3/167; G06F 3/162

(57) ABSTRACT

A method for rendering an audio content as part of an interactive digital service, implemented by an electronic audio content rendering device embedded in an audio content rendering equipment. The method includes, after obtaining and rendering an audio content: detecting an interaction between a user and the rendering equipment; and, in response to the detecting, generating and transmitting at least one instruction to an electronic audio content provision device so that it determines at least one parameter to obtain a next audio content expected by the user as part of the digital service; and transmitting the instruction triggering the rendering of the next audio content.

### TECHNICAL FIELD

The disclosed technology relates to the general field of interactive digital services, and more particularly concerns a method for rendering an audio content as part of an interactive digital service. It also concerns a method for providing an audio content in an interactive digital service.

### DESCRIPTION OF RELATED TECHNOLOGY

The access to an audio content adapted to a user is a major issue. One way to address this issue is to facilitate the navigation in an audio content. For this, the user has basic functionalities such as accessing the beginning of the audio content, accessing a particular chapter of the audio content, browsing the audio content or even pausing. However, these functionalities or these modalities of interaction with a digital service are limited since they do not allow the user to easily obtain a more or less enhanced audio content.

It would therefore be advantageous that the interactive services meet or even anticipate the wishes of the user to provide on demand a more or less enhanced content corresponding to the wishes of the user. When these services are deployed on servers and accessed by terminals, this real-time adaptation criterion proves to be crucial for the service provider and for the telecommunications operator since, if the provided content meets more precisely the wishes of the user, the resources of the server will also be released more quickly, and the time of occupancy of the telecommunications network will be reduced.

One solution to determine the wishes of the user would be to analyze the explicit verbal expressions of the user, but such a solution would be excessively complex, computationally intensive, and could lead to a misinterpretation of the wishes of the user by the service.

The disclosed technology aims in particular to overcome these drawbacks.

### SUMMARY

According to a first aspect, the disclosed technology concerns a method for rendering an audio content as part of an interactive digital service, implemented by an electronic audio content rendering device embedded in an audio content rendering equipment, the method comprising, after obtaining and rendering an audio content,
detecting a physical interaction between a user and the rendering equipment; and, in response to the detection,
generating and transmitting an instruction to an audio content provision device so that it determines at least one parameter to obtain a next audio content expected by the user as part of the digital service, the next audio content (F2) being associated with another level of information higher or lower than that of the audio content (F1).

Advantageously, the transmission of the discrete instruction triggers the rendering of the next audio content.

In particular implementations, the instruction is a discrete instruction chosen by the electronic audio content rendering device and expected by the audio content provision device among a finite set of predetermined instructions. Thus, to determine the wishes of the user with a view to providing him with a more or less enhanced content which meets his wishes, the disclosed technology takes the bias of determining an adapted audio content on the basis of a limited set of discrete instructions. Unlike a solution that would consider an analysis based on an automatic processing of the language of a verbal description of these wishes, the disclosed technology has the advantage of having low complexity.

Preferably, the interaction with the rendering equipment is generic, that is to say independent of the type of digital service, and simple so as to improve the user experience.

In particular implementations, the at least one parameter is a context parameter of use of the rendering equipment.

By context parameters of use of the rendering equipment, it is meant parameters specific to the user of the rendering equipment, such as his language, his age, his level of knowledge, his mood or his state of mind; and/or parameters specific to the rendering equipment such as its geographical location or the audio rendering means used (e.g., loudspeakers or headphones); and/or parameters characterizing the environment in which the rendering equipment is used (e.g., a noisy, quiet, crowded or deserted environment). An audio content can thus be adapted as a function of these parameters, for example by adding, deleting or replacing portions of the audio content, or by applying a sound signal processing method to the audio content.

In particular implementations, the instruction is a binary instruction.

In particular implementations, an information associated with the instruction and representing the audio content rendered at the moment of the interaction is transmitted to the electronic audio content provision device.

In this way, the electronic audio content provision device is able to know the state of the service at the moment of the interaction, which allows it to best adapt the next audio content.

In particular implementations, the rendering of the audio content is interrupted.

If the user interacts with an audio content rendering equipment, for example his Smartphone, with a view to obtaining an audio content, this means that the content of the current stream does not sufficiently meet his wishes. In order to create an engaging user experience, it can therefore be advantageous to interrupt the rendering of an audio content that is not suitable.

In particular implementations, the audio content is associated with a level of information and parameterization, the next audio content being associated with another level of information higher or lower than that of the audio content, in which the instruction is an instruction interpreted as aiming to obtain a content of a higher or lower level of information.

By interacting with a rendering equipment, the user thus expresses his wish to obtain a more or less enhanced content, and this interaction is then interpreted as aiming to obtain a content with a higher or lower level of information.

Within the meaning of the disclosed technology, a content F2 is enhanced when it takes into account a number of context parameters of use of the rendering equipment greater than the number of context parameters of use considered to generate the content F1, or when the value of at least one of the context parameters associated with the audio content F2 characterizes a more precise context than the value of the same parameter associated with the audio content F1. Conversely, a content F2 is reduced when it takes into account a number of context parameters of use of the rendering equipment smaller than the number of context parameters of use considered to generate the content F1, or when the value of at least one of the context parameters associated with the audio content F2 characterizes a more general context than the value of the same parameter associated with the audio content F1. Thus, the audio content F2 is associated with another level of information respectively higher or lower than that of the audio content F1.

In particular implementations, a content F2 is enhanced when the value of at least one of the context parameters associated with the audio content F2 is greater than the value of the same parameter associated with the audio content F1. Conversely, a content F2 is reduced when the value of at least one of the context parameters associated with the audio content F2 is smaller than the value of the same parameter associated with the audio content F1.

In particular implementations, the electronic audio content provision device is embedded in an audio content provision equipment distinct from the audio content rendering equipment, and in this case, the audio content corresponds to at least one audio stream transmitted by a communication channel, and the instruction is sent to the audio content provision equipment by a communication channel constituted by one among the following communication channels:
the communication channel through which the at least one audio stream is transmitted;
a communication channel distinct from the communication channel through which the at least one audio stream is transmitted.

According to a second aspect, the disclosed technology concerns a rendering equipment comprising an electronic audio content rendering device, the device comprising: a device for rendering an audio content as part of an interactive digital service; a detector of an interaction between a user and the rendering equipment; a generator configured, upon detection of the interaction, to generate an instruction intended for an electronic audio content provision device so that it determines at least one parameter to obtain a next audio content as part of said service, the next audio content being associated with another level of information higher or lower than that of the audio content; and a transmitter of the instruction to said electronic audio content provision device.

In particular implementations, the equipment comprises at least one button configured to generate a signal representative of the activation of said button, and means for routing said signal to said detector.

The use of buttons, preferably two buttons, to generate a signal representative of the wish or of the need of the user makes it possible to obtain an intuitive, friendly and easy-to-use interface, whatever the profile of the user.

According to a third aspect, the disclosed technology relates to a method for providing an audio content as part of an interactive digital service, the method being implemented by an electronic audio content provision device, the method comprising, after obtaining a current content generated from a set of context parameters of use of a rendering equipment: receiving an instruction issued by an electronic audio content rendering device to obtain a next audio content, the next audio content (F2) being associated with another level of information higher or lower than that of the audio content (F1); obtaining the next audio content at least part of which takes into account at least one context parameter of use of the rendering equipment determined as a function of the instruction and of the set of context parameters of at least one audio content prior to the next content; and transmitting a data relating to the next content to an electronic audio content rendering device of the rendering equipment.

In particular implementations, the next content includes at least one unsent part of said current content, and at least one part not comprised in said current content and obtained in accordance with the aforementioned obtaining step.

In this way, the content that it was initially planned to render to the user is adapted by taking into account the different criteria, so as to provide a content that meets more precisely the wishes of the user.

In particular implementations, obtaining said next content takes into account a state of said service at the moment of the interaction. Particularly, the electronic audio content provision device can determine the instant rendered at the moment of the interaction, and thus deduce therefrom the part of the current stream that has not yet been rendered.

In particular implementations, an association is predetermined between at least part of the current stream and at least part of the next content obtained in accordance with said aforementioned obtaining step, as a function of context parameters of use of the rendering equipment.

In particular implementations, an association between at least part of the current stream and at least part of the next content obtained in accordance with the aforementioned obtaining step is determined in response receiving the instruction.

In particular implementations, an audio content is associated with a video content so as to form a multimedia content, and receiving an instruction triggers obtaining a next video content synchronized with the next audio content.

According to a fourth aspect, the disclosed technology concerns an electronic device for providing an audio content as part of an interactive digital service comprising: a receiver of an instruction issued by an electronic audio content rendering device of a rendering equipment as part of said service; a device for obtaining a next audio content intended to be sent to the electronic audio content rendering device, at least part of said next audio content taking into account at least one context parameter of use of said rendering equipment determined as a function of the instruction and of the set of context parameters of a content prior to said next content; the next audio content (F2) being associated with another level of information higher or lower than that of the audio content (F1); and a transmitter of a data relating to the next content to the electronic audio content rendering device of the rendering equipment.

In particular implementations, the different steps of the audio content rendering and provision methods are determined by computer program instructions.

Consequently, the disclosed technology also relates to a computer program on an information medium, this program being capable of being implemented in an electronic audio content rendering device, in an electronic audio content provision device, or more generally in a computer, this program including instructions adapted to the implementation of the steps of an audio content rendering and/or provision method as described above.

This program can use any programming language, and be in the form of source code, object code, or intermediate code between source code and object code, such as in a partially compiled form, or in any other desirable form.

The disclosed technology also relates to an information or recording medium readable by a computer, and including instructions of a computer program as mentioned above.

The information or recording medium can be any entity or device capable of storing the program. For example, the support can include a storage means, such as a ROM (e.g., a PROM, an EPROM, an EEPROM), for example a CD ROM or a microelectronic circuit ROM, or a magnetic recording means, for example a floppy disk or a hard disk.

On the other hand, the information or recording medium can be a transmissible medium such as an electrical or optical signal, which can be routed via an electrical or optical cable, by radio or by other means. The program according to the disclosed technology can be particularly downloaded onto an Internet type network.

Alternatively, the information or recording medium can be an integrated circuit in which the program is incorporated, the circuit being adapted to execute or to be used in the execution of one of the methods in question.

### BRIEF DESCRIPTION OF THE DRAWINGS

Other characteristics and advantages of the present disclosed technology will emerge from the description given below, with reference to the appended drawings which illustrate one exemplary embodiment without any limitation. In the figures:

FIG. 1 schematically represents one example of architecture of a system in which the disclosed technology can be implemented;

FIG. 2 schematically represents a device for rendering an audio content or a device for providing an audio content according to one exemplary embodiment of the disclosed technology;

FIG. 3 illustrates one example of a change in the levels of information wished by a user over time, which results for example from one implementation of the method of FIG. 4;

FIG. 4 represents, in the form of a flowchart, the main steps of a method for managing an audio stream by an equipment for rendering an audio content and an equipment for providing an audio stream as part of an interactive digital service;

FIG. 5 represents, in the form of a flowchart, the main stages of a method for managing an audio stream by an equipment for rendering an audio content as part of an interactive digital service; and,

FIG. 6 schematically represents one example of an audio content structuring according to different levels of information, as a function of the value of a discrete instruction.

### DETAILED DESCRIPTION OF ILLUSTRATIVE EMBODIMENTS

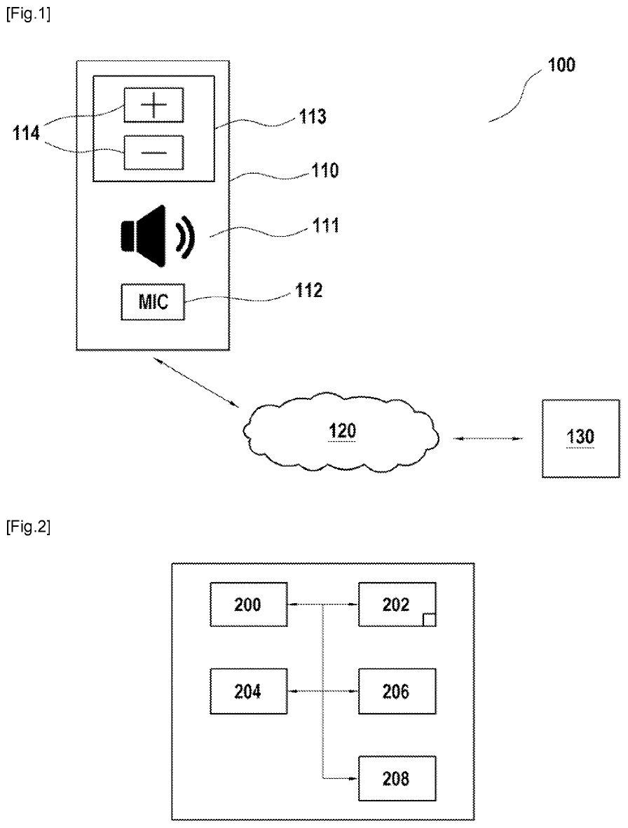

FIG. 1 schematically represents one example of architecture of a system in which the disclosed technology is implemented. The system 100 comprises an equipment 110 for rendering an audio content as part of a digital service, which is connected to a telecommunications network 120, for example a radio network, the Internet, a Wi-Fi network, a Bluetooth network, or a fixed or mobile telephone network.

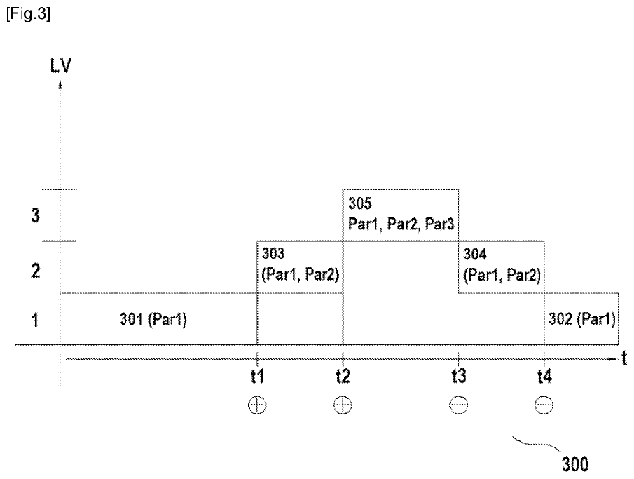

FIG. 2 schematically represents one example of an electronic device according to one embodiment of the disclosed technology. The electronic device has the conventional architecture of a computer and is for example embedded in an audio content rendering equipment 110. It comprises in particular a processor 200, a read only memory 202 (of the “ROM” type), a rewritable non-volatile memory 204 (of the “EEPROM” or “NAND Flash” type for example), a rewritable volatile memory 206 (of the “RAM” type), and a communication interface 208.

In this example, the read only memory 202 constitutes an information (or recording) medium conforming to particular implementations of the disclosed technology. In the read only memory 202, a computer program P1 is stored allowing the electronic device to implement a rendering method conforming to one exemplary embodiment of the disclosed technology. As a variant, the computer program P1 is stored in the rewritable non-volatile memory 204. A computer program P2 can also allow this electronic device to implement a method for providing an audio content as part of an interactive digital service. This program P2 is for example stored in the read only memory 202, or in the rewritable non-volatile memory 204.

The rendering equipment 110 comprises means for receiving an audio stream as part of a digital service, particularly an audio stream decoder, and audio rendering means, such as loudspeakers 111 or a connection audio output (not represented) for headphones.

The equipment 110 also comprises means for detecting an interaction between a user and the equipment 110, such as a detection module (or detector) associated with a microphone 112 and making it possible to detect a voice command issued by the user, or a detection module associated with a mechanical button or a button of a tactile interface 113. The button is configured to generate a signal representative of the activation of the button, and the microphone is configured to generate a signal representative of a voice command. Routing means make it possible to transmit the representative signal to the detection module. Preferably, the equipment 110 comprises two buttons 114, one to generate a signal characterizing that an enhanced audio content is desired, the other to generate a signal characterizing that a reduced audio content is desired.

Finally, the equipment 110 comprises means for generating (or generator) and transmitting (or transmitter) an instruction. When the disclosed technology is implemented by an equipment 110 and a provision equipment 130, the instruction can be a DTMF (dual-tone multi-frequency) code or correspond to a data packet transmitted with a view to obtaining an enhanced or a reduced audio stream. The instruction can be transmitted via the telecommunications network 120, by using the same channel or a distinct channel from the one used to receive the audio stream, or via another telecommunications network.

Furthermore, the rendering equipment can also comprise visual rendering means, such as a display screen and/or a light-emitting diode. Particularly, the equipment 110 for rendering a digital audio service can be a terminal such as a landline or mobile telephone, a computer, a digital tablet, etc.

A “digital audio service” consists of at least one audio content which is obtained by the rendering equipment 110, with a view to being rendered by this equipment 110. It can be for example:
a service of the “audio book” type for which a text whose reading aloud has been recorded is rendered by the equipment 110;
a service of the “audio guide” type which allows a user of the equipment 110 to take a guided tour of a tourist site, by using his equipment 110 which delivers audio commentaries, as a cultural guide would do;
a service of the “interactive audio course” type which allows a user of the equipment 110 to train by listening to an educational audio resource; or,
a service of the “personal assistant” type configured to answer questions asked by a user.

When the electronic device is configured to implement the provision method, it also comprises means for receiving (or receiver) an instruction, means for obtaining an audio content, and means for transmitting (or transmitter) a data relating to the next content.

The system also comprises an equipment 130 for providing an audio content as part of a digital service, which is connected to the telecommunications network 120. The provision equipment 130 also comprises an electronic device which has the conventional architecture of a computer. It can then include in particular a processor 200, a read only memory 202 (of the “ROM” type), a rewritable non-volatile memory 204 (of the “EEPROM” or “NAND Flash” type for example), a rewritable volatile memory 206 (of the “RAM”), and a communication interface 208.

Each read only memory can constitute a recording medium conforming to one exemplary embodiment of the disclosed technology, readable by the associated processor and on which a computer program conforming to one exemplary embodiment of the disclosed technology is recorded. As a variant, the computer program is stored in the associated rewritable non-volatile memory. The computer program can allow the implementation of the provision method conforming to one exemplary embodiment of the disclosed technology.

The equipment 130 comprises means for receiving (or receiver) an instruction, means for obtaining an audio content, and means for transmitting (or transmitter) a next content or a data relating to the next content. Furthermore, if the instruction is a DTMF code issued by the rendering equipment 110, the equipment 130 is equipped with a recognition module configured to recognize different frequencies.

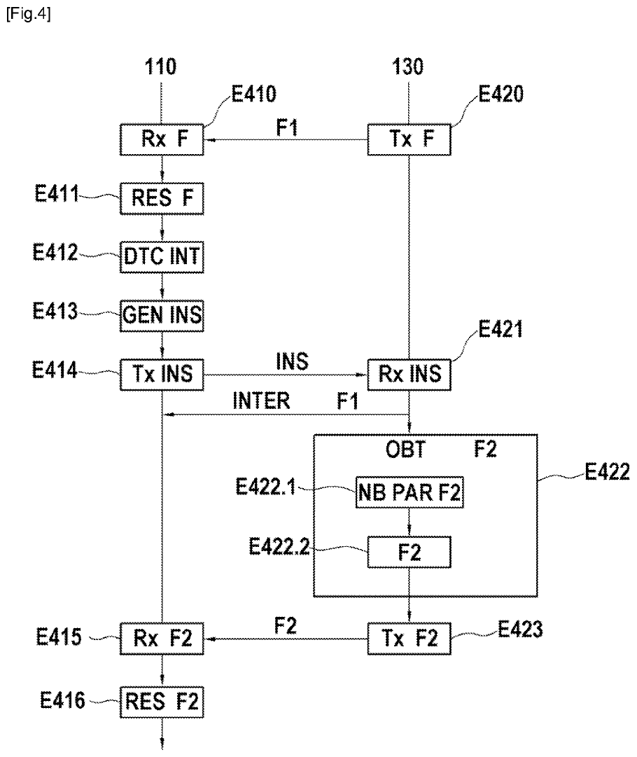

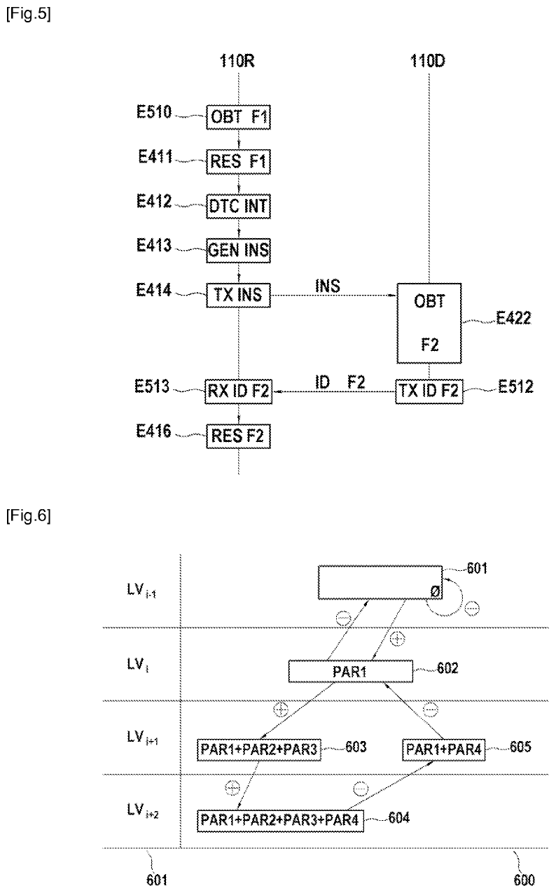

FIG. 3 illustrates one example of a change in the information and parameterization levels (LV) desired by a user interacting with a digital service proposing an audio content, which results for example from an implementation of the method of FIG. 4 or FIG. 5.

The number of possible information and parameterization levels (LV) depends on the type of interactive digital service, and/or on the ongoing action. The ongoing action corresponds for example to a response to a question of the user, a description to configure hardware, a spontaneous proposal from the service, a commentary on a viewed map, or an all public or a confidential content.

In this example, a user accesses via his audio content rendering equipment 110 an initial audio content 301 having a level of information equal to 1. As a variant, the initial audio content is associated with a higher level of information (LV) (e.g., 2). A context parameter Part of use of the equipment 110 is applied by the interactive digital service to the audio content 301. The audio content can for example correspond to a text whose reading aloud has been recorded, to a music or to a sound.

At instant t1, the user indicates by an order represented by a ‘+’ he wishes to obtain an enhanced content, that is to say here a content interpreted by the audio content provision device as being a content of level 2.

Thus, an audio content F1 is for example enhanced when in response to the application or non-application of context parameters, additional audio content portions PS are added to the audio content F1, or replace some portions or all of the audio content F1, so as to form an audio content F2. In one particular example, an audio content F1 corresponding to a text whose reading aloud has been recorded is enhanced when new audio portions whose content for example also corresponds to a text whose reading aloud has been recorded, are added to the audio content F1. This is for example the case when additional examples or details are added to the content F1, or when some sentences from the initial text are repeated. Alternatively, the content F1 can be enhanced by adding pauses, sounds or music at certain instants.

According to another particular example, an audio content F1 comprises a background noise which makes it difficult to understand a text whose reading aloud has been recorded. By taking into account additional context parameters (which characterize for example the fact that the content is listened to by a user with a hearing loss), an enhanced content F2 can be generated which corresponds to the text of the audio content F2, but on which a noise reduction processing has been applied. In other words, the audio content F2 is enhanced, but comprises less information than the audio content F1.

According to another particular example, an initial audio content F1 is for example adapted to an elementary school student. By choosing to obtain an enhanced audio content, a new context parameter which corresponds for example to the fact that the student is in kindergarten is applied, and some portions of the audio content F1, which have not yet been rendered and which are considered unsuitable given the level of the student, are deleted. In other words, the audio content F2 is enhanced by the application of an additional parameter, and it comprises different information, more adapted to the context. But in this example, the enhanced content F2 is shorter than the content F1.

This operation can be repeated several times (here at instants t1 and t2) in order to each time obtain a more enhanced audio content than the one rendered by the rendering equipment 110 at the moment when the order is indicated. Thus, between instants t1 and t2, a content 303 interpreted as being of level 2 and to which for example two context parameters Par1 and Par2 of use of the equipment 110 are applied, is rendered. Between instants t2 and t3, a content 305 interpreted as being of level 3 and to which three context parameters Par1, Par2 and Par3 of use are applied, is rendered.

Conversely, the user may wish to obtain a reduced content. In one particular example, an audio content F1 corresponding to a text whose reading aloud has been recorded is reduced when some audio portions of the audio content F1 are deleted.

According to another particular example, an initial audio content F1 is for example adapted to a kindergarten student. By choosing to obtain a reduced audio content, a context parameter hitherto applied and which characterized the level of the user is no longer applied by the service, and new portions are added to the audio content F1, so to generate an audio content F2 having a basic level, for example adapted to an elementary school student. Thus, in this example, the reduced content F2 obtained is longer than the content F1.

At instants t3 and t4, the user indicates by an order represented by a ‘-’ that he wishes to obtain a reduced content, that is to say a content interpreted as being of a lower level than that of the currently rendered content. Thus, between the instants t3 and t4, a content 304 of level 2 to which the two context parameters Par1 and Par2 of use of the equipment 110 are applied, is rendered. Then from instant t4, a content 302 having a content of level 1 and to which the context parameter Part of use of the equipment 110 is applied, is rendered.

According to particular implementations, the content 302 corresponds in some way to the continuation of the content 301 that it was planned to render immediately after the portion 301 had been, but that had ultimately not been rendered to the user after detection of an interaction at instant t1. In the same way, the content 304 corresponds in some way to the continuation of the content 303 that it was planned to render immediately after the content 303 had been, but that had ultimately not been rendered to the user after the detection of an interaction at instant t2.

As a variant, the content 302 does not correspond exactly to the continuation of the content 301 that it was planned to render immediately after the content 301 had been. In this case, the content 302 rendered from instant t4 takes into account for example the history of the actions performed by the user at instants t1 to t4. If the parameter Par1 corresponds for example to the value of a level of knowledge of the user, this level of knowledge can be regularly updated, for example after an interaction with a user of the equipment 110 is detected. In this case, the value of the parameter Par1 associated with the content 301 is not identical to that of the parameter Par1 associated with the content 302.

As a variant, the number of parameters applied between two consecutive time intervals (for example between the intervals [t1, t2] and [t2, t3]) is identical, but the value of at least one of the applied parameters changes. This is for example the case when a user wishes, through his actions, to amplify or reduce the same adaptation phenomenon (e.g., a level of knowledge).

The order of passage to an enhanced or reduced content can be indicated by the user by considering one of the following modalities:
by pressing a button on the audio content rendering equipment 110 or on a remote control associated with the equipment 110. The button can be either a push button or a button on a touch interface 113. Preferably, the rendering equipment 110 comprises two buttons 114, one to generate a signal characterizing that an enhanced content is desired, the other to generate a signal characterizing that a reduced content is desired.
by an elementary voice command (for example a single word or a limited number of words) issued by the user. A microphone 112 of the equipment 110 is associated with a detection module which decodes and analyzes the received audio signal. The instruction of the user is then determined by comparing the received signal with other basic signals recorded in the memory of the equipment 110, these basic signals being associated with information indicating whether an enhanced or reduced content is desired.
by a specific movement of the equipment 110 or of the user detected by a sensor (not represented), for example a camera or a gyroscope embedded in the rendering equipment 110. A detection module is coupled to this sensor which analyzes the detected movement and generates a signal. The instruction of the user is then determined by comparing the signal with other basic signals recorded in the memory of the equipment 110, these basic signals being associated with an information indicating whether an enhanced or reduced content is desired.

According to particular implementations, in response to the rendering of an enhanced or reduced audio content, also called next content, an acknowledgment information is generated by the rendering equipment 110. This acknowledgment information is for example generated in response to obtaining the next content, and allows the user to be informed that his wish for a new content has been taken into account.

Thus, the user can be informed of the receipt of a next content by different modalities:
by visual rendering means of the rendering equipment 110, such as a display screen for example temporarily displaying a visual information characterizing the rendering of a next content, or displaying the level of information corresponding to the next rendered content. The level of information depends for example on the number of parameters or on the values of context parameters taken into account by the service. As a variant, these means comprise a light-emitting diode of the rendering equipment 110 which lights up temporarily in the event of rendering of a next content, or whose light intensity varies as a function of the level of information of the rendered content.
by sound information generation means. A beep sound is for example temporarily emitted in case of rendering of a next content. The beep sound can also allow the user to identify the level of information of the next content, for example by adapting the duration of the beep as a function of the level or by emitting several consecutive beep sounds whose number depends on the level of information of the next content. As a variant, beeps of different tones can be generated which characterize whether the next content is enhanced or reduced compared to the initial content. As a variant, a verbal indication which indicates that a next content is about to be rendered, or which specifies the level of information of the content about to be rendered, is rendered just before the next content is rendered.

As a variant, when the disclosed technology is implemented by a rendering equipment 110 and an audio content provision equipment 130, the acknowledgment information can be a sound information which is generated by the provision equipment 130, and transmitted either by using the same communication channel as the one used to transmit the enhanced or reduced content to the rendering equipment 110, or by using another communication channel. As previously, the sound information can be a beep sound or a sequence of beep sounds whose frequency and/or duration can vary, or a verbal indication which indicates that a next content is about to be rendered, or even which specifies the level of the next content.

FIG. 4 represents, in the form of a flowchart, the main steps of a method for managing an audio content by a rendering equipment 110 and an equipment 130 for providing an audio content as part of an interactive digital service. This method is typically implemented when the user of a rendering equipment 110 wishes to obtain an audio content as part of a digital service, whose content adapts in response to an instruction from the user and as a function of context parameters of use of the rendering equipment 110. The desired audio content is typically managed by a service provider in charge of the management of an audio content provision equipment 130. In this context, an audio content is also called “audio stream”.

In such a situation, the user of the equipment should first identify or authenticate himself with the digital audio service provider responsible for managing the audio stream provision equipment 130. If the provider proposes several digital audio services, the user selects one of them, for example through the touch screen of the rendering equipment 110.

A stream F1 generated by an audio stream provision equipment 130 is transmitted (E420) then received by an equipment 110 during a first step E410 and rendered to the user of the equipment 110 during a step E411. During or at the end of the rendering of the stream F1, the equipment 110 detects a physical interaction E412 with a user.

As indicated with reference to FIG. 3, the detected interaction can correspond:
to a push of a button on the equipment 110 or on a remote control associated with the equipment 110;
to an elementary voice command issued by the user;
or to a specific movement of the user which is detected by a sensor associated with the equipment 110.

Once the interaction is detected, the equipment 110 can then determine, for example using a detection and analysis module, whether the interaction aims to obtain an enhanced content (e.g., a content interpreted by the provision equipment 130 as being of a higher level than that of the currently rendered stream) or a reduced content (e.g., a content interpreted by the provision equipment 130 as being of a lower level) compared to the content of the stream F1. Then, the rendering equipment 110 generates, during a step E413, an instruction which is sent to the audio stream provision equipment 130 during a step E414.

In particular implementations, the instruction is a discrete instruction chosen by the electronic audio content rendering device and expected by the audio content provision device among a finite set of predetermined instructions. When this number is equal to 2, the discrete instruction is called binary instruction. In this example, the instruction INS is a binary instruction that characterizes whether the desired stream is an enhanced or a reduced audio stream.

The instruction is transmitted to the equipment 130 either by the same communication channel as the one used to receive the stream F1 during step E410, or by another communication channel. More particularly, the instruction can be a DTMF (dual-tone multi-frequency) code, and in this case the information according to which an enhanced or reduced content is desired is coded in the form of an audio signal at different frequencies. As a variant, a message is sent to the equipment 130 which may correspond to a data packet for example conforming to the IP protocol, and which includes a parameter whose value makes it possible to identify whether an enhanced or a reduced content is desired.

In response to receiving an instruction during a step E421, the provision equipment 130 determines whether the instruction is obtained with a view to obtaining an enhanced or a reduced content. Optionally, the value of at least one context parameter which considers the history of the streams rendered by the equipment and/or the history of the interactions is updated. This parameter represents for example a level of knowledge of the user.

Then, during a step E422, the provision equipment 130 obtains a next stream F2 with an enhanced or a reduced content compared to that of F1, and which aims to anticipate the wishes of the user. To do so, the equipment 130 consults a data structure associated with the digital audio service and which is for example stored in the rewritable non-volatile memory 204. This data structure associates a first information identifying an enhanced stream and/or a second information identifying a reduced stream with a current stream corresponding to a level of information (LVi). These enhanced and reduced streams result for example from the application of a list of parameters with which values are associated to a reference audio content. The stream is for example also stored in the rewritable non-volatile memory 204, and may have been previously generated by the device 130 or obtained from another audio content provision device.

In particular implementations, the next stream F2 is generated on the fly. If the instruction received in step E421 is obtained with a view to obtaining an enhanced content, the equipment 130 determines, as a function of the level of information (LVi) of the rendered stream F1, parameters and values of these parameters applied to the stream F1, a list of additional parameters to be applied to the stream F1 (E422.1), so as to obtain an enhanced stream F2 (E422.2) which is interpreted by the provision device 130 as belonging to a higher level of information (LVi+1). As a variant, the equipment 130 updates the value of at least one of the context parameters associated with the audio content F1, this updated value characterizing a more precise context than the value of the same parameter associated with an audio content F1. Similarly, if the instruction received in step E421 is obtained with a view to obtaining a more reduced content, the equipment 130 determines, as a function of the level of information (LVi) of the rendered stream, parameters applied to the stream F1 and values of these parameters, a list of parameters to be applied to the stream F1 (E422.2) whose number is smaller than that of the parameters hitherto applied to the stream F1 so as to obtain a reduced stream F2 and interpreted by the provision device 130 as belonging to a lower level of information (LVi−1). As a variant, the equipment 130 updates the value of at least one of the context parameters associated with the audio content F1, this updated value characterizing a more reduced context than the value of the same parameter associated with the audio content F1.

In this case, optionally, an interruption message INTER_F aimed at interrupting the rendering of the current stream is transmitted by the provision equipment 130 to the equipment 110.

In particular implementations, the application of context parameters to a stream F1, whether with a view to obtaining a next enhanced or reduced stream F2, leads to the addition or the deletion of at least one additional audio content portion to/from the part PF1 of the current stream F1 that has not yet been rendered.

For this, optionally, the equipment 130 determines the rendered instant Tr at the moment of the detection of the interaction, and deduces therefrom which part PF1 of the current stream F1 has not yet been rendered. This part PF1 is for example determined as a function of the interaction detection time Tc, of the time of transmission of the current stream between the equipment 110 and 130, of the time between the receipt of the current stream and its rendering by the equipment 130, and of the transmission and analysis time of the discrete instruction. As a variant, the part PF1 is deduced from an information transmitted by the receiving equipment 110. This information corresponds for example to the instant of rendering of the stream when the instruction of the user has been detected. It can be transmitted in parallel with the instruction transmitted in step E414, using a message conforming to the IP protocol. Once the part PF1 has been determined, the provision equipment 130 determines for example which audio content must be added to or deleted from the part PF1.

As a variant, in response to receiving an instruction in step E421, the equipment 130 adapts the untransmitted audio stream, without determining the instant rendered at the moment of the detection of the interaction. In this case, the instant Tr below corresponds to the current time. This variant is particularly advantageous when the volume of data stored by the equipment 110 before being rendered is small.

If the instruction received in step E421 is obtained with a view to obtaining an enhanced content in which an additional audio content portion is added, it consults a first association table TAB1 which associates with a given level of information (LVi), at least one additional portion PS to be added to the stream of lower level (LVi−1), and which also comprises an information making it possible to determine its position in the stream. According to the position information associated with each portion PS, and to the time Tr, the provision equipment 130 determines the additional portion(s) PS to be added or replacing other portions of the stream of lower level (LVi−1). The position at which each additional portion PS must be inserted in the audio stream is predetermined, for example depending on the type of service. Thus, a next stream F2 is generated which results from the addition of at least one additional portion PS to the stream F1.

Similarly, if the instruction received in step E421 is obtained with a view to obtaining a reduced content in which an additional audio content portion is deleted, it consults a second association table TAB2 which associates with a given level of information (LVi) at least one portion PS which must be deleted from the non-rendered part of the current stream, and an information making it possible to identify the position of this portion PS in the part of the non rendered stream. According to the position information associated with each portion PS, and to the time Tr, the provision equipment 130 determines the additional portion(s) PS to be deleted or replacing other portions of the stream of higher level (LVi+1). Thus, a next stream F2 is generated which results from the deletion of at least one additional portion PS of the stream F1. Finally, during a step E423, the next stream is transmitted by the provision equipment 130 to the rendering equipment 110, and received, during a step E415, by the rendering equipment 110. Once received, the next stream can be recorded in a rewritable non-volatile memory 204, and/or rendered by the rendering equipment 110 (E416).

FIG. 5 represents, in the form of a flowchart, the main steps of a method for managing an audio content by a content rendering equipment 110 as part of an interactive digital service. Unlike the method illustrated in FIG. 4, the method of FIG. 5 is only implemented by a rendering equipment 110, such as a terminal, which comprises both an electronic audio content rendering device 110R, and an audio content provision device 110D. The steps bearing the same reference as a step described with reference to FIG. 4 are identical, and therefore not detailed below.

In this example, an audio content F1 which was previously stored in a rewritable non-volatile memory 204 of the equipment 110 is obtained by an electronic device 110R during a step E510, then rendered to the user of the equipment 110 during a step E411. During or at the end of the rendering of the audio content F1, the equipment 110 detects an interaction with a user (E412), then generates, during a step E413, an instruction (INS) which is sent during a step E414 to the audio content provision device 110D. During a step referenced E422, the audio content provision device 110D obtains a next content F2.

During a step E512, the audio content provision device 110D transmits a data making it possible to retrieve the next content, for example an identifier, or an address of the rewritable non-volatile memory, which is received by the device 110R during a step E513.

Once the data has been received, the next content can be rendered by the rendering equipment 110 during a step E416.

With reference to one of FIG. 4 or 5, in particular implementations, at least one of the applied context parameters (for example Par1) is a coding parameter, whose value depends on the level of information associated with the next stream. This coding parameter corresponds for example to the application of a frequency to the audio signal corresponding to the next stream. Thus, if the more the audio content is interpreted as belonging to a high level of information, the more a high frequency is applied to the corresponding audio signal, and if in the same way the more the audio content is interpreted as belonging to a low level of information, the more a lower frequency is applied to the corresponding audio signal, a text whose reading aloud has been recorded is rendered to the user with a more or less high-pitched voice, as a function of the level of information of this content. In the particular case where the context parameter is a coding parameter, it can be applied by the audio content provision device during step E422, or applied by the audio content rendering device during or just before the step E416.

FIG. 6 schematically represents one example of an audio content structuring 600 according to different levels of information, as a function of a value of a discrete instruction. As indicated with reference to FIGS. 4 and 5, this structuring is browsed by the content provision device (110D, 130) to determine the parameters to be applied when a content of a level of information different from that of the current content must be generated.

In this example, the reference 602 represents an initial content corresponding to a content 601 to which a context parameter Par1 is applied, which is associated with an initial level of information LVi. If this content 602 is rendered when an instruction is received in step E421 is obtained with a view to obtaining an enhanced content (+), two new parameters Par2 and Par3 are applied to the content 602, so that a content 603 is generated. This content 603 is associated with a level of information LVi+1. If, on the other hand, the instruction received in step E421 is obtained with a view to obtaining a reduced content (−), a content 601 to which no context parameter is applied is generated. This content 601 is associated with a level of information LVi−1.

If the content 603 is rendered when an instruction received in step E421 is obtained in order to obtain an enhanced content (+), a new content 604 is generated which corresponds to the content 603 to which an additional context parameter Par4 is applied. This content 604 is associated with a level of information LVi+2.

If the content 604 is rendered when an instruction received in step E421 is obtained with a view to obtaining a reduced content (−), a new content 605 is generated which corresponds to the content 604 to which two context parameters Par2 and Par3 are no longer applied. This content 605 is associated with a level of information LVi+1.

Finally, if the content 605 is rendered when an instruction received in step E421 is obtained with a view to obtaining a reduced content (−), this amounts to generating the content 602 associated with the level of information LVi.

In particular implementations of the disclosed technology, the audio content is associated with a video content. The video content is synchronized with the audio content, and the video content is for example decoded so as to obtain a video sequence which is displayed on the screen of the rendering equipment 110. In this case, an interaction of a user with a view to obtaining a more or less enhanced audio content also leads to an adaptation of the video sequence. Thus, if the instruction received in step E421 is obtained with a view to obtaining an enhanced audio content, this for example automatically leads to the playing of a new video sequence associated with a region of interest that was viewed at the moment of interaction, or a zoom of the visual information. In other words, enhancement by “zooming” an audio content automatically leads to “zooming” the viewed information. Optionally, skips can also be made in the video content that it was initially planned to display, and some video content portions are therefore not presented to the user.

Similarly, if the instruction received in step E421 is obtained with a view to obtaining a reduced audio content, this for example automatically leads to playing a new video sequence associated with the video portion that was viewed at the moment of the interaction or to zooming out the visual information. In other words, when the audio stream is reduced by deleting some portions, this “zoom out” on the audio stream automatically leads to a “zoom out” of the viewed information. Optionally, skips can also be made in the video content that it was initially planned to display, and some video content portions can be presented to the user again.

Although the present disclosure has been described with reference to one or more examples, workers skilled in the art will recognize that changes may be made in form and detail without departing from the scope of the disclosure and/or the appended claims.

1. A method for rendering an audio content as part of an interactive digital service, implemented by an electronic audio content rendering device embedded in an audio content rendering equipment, the method comprising, after obtaining and rendering the audio content,
detecting a physical interaction between a user and the audio content rendering equipment; and, in response to the detection,
generating and transmitting an instruction to an electronic audio content provision device so that the electronic audio content provision device determines at least one parameter to obtain a next audio content expected by the user as part of the interactive digital service, the transmission of the discrete instruction triggering a rendering by the audio content rendering equipment of the next audio content, the next audio content being associated with another level of information higher or lower than that of the audio content.

2. The method of claim 1, wherein the at least one parameter is a context parameter of use of the audio content rendering equipment.

3. The method of claim 1, wherein the instruction is a binary instruction.

4. The method of claim 1, further comprising transmitting to the electronic audio content provision device an information associated with the instruction and representing the audio content rendered at the moment of the interaction.

5. The method of claim 3, wherein the audio content is associated with a level of information and parameterization, in which the instruction is an instruction interpreted as aiming to obtain a content of a higher or lower level of information.

6. A rendering equipment comprising an electronic audio content rendering device, the device comprising:
at least one processor; and
at least one non-transitory computer readable medium comprising instructions stored thereon which when executed by the at least one processor configure the audio content rendering device to:
render an audio content as part of an interactive digital service;
detect an interaction between a user and the rendering equipment;
upon detection of the interaction, generate an instruction intended for an electronic audio content provision device so that the electronic audio content provision device determines at least one parameter to obtain a next audio content as part of said interactive digital service, the next audio content being associated with another level of information higher or lower than that of the audio content; and
transmit the instruction to said electronic audio content provision device.

7. The rendering equipment of claim 6 comprising at least one button configured to generate a signal representative of an activation of said button, and which is routed to said detector.

8. A method for providing an audio content as part of an interactive digital service, the method being implemented by an electronic audio content provision device, the method comprising, after obtaining a current audio content generated from a set of context parameters of use of a rendering equipment:
receiving an instruction issued by an electronic audio content rendering device to obtain a next audio content, the next audio content being associated with another level of information higher or lower than that of the current audio content;
obtaining the next audio content at least part of which takes into account at least one context parameter of use of the rendering equipment determined as a function of the instruction and of the set of context parameters of at least one audio content prior to the next content;
transmitting a data relating to the next audio content to the electronic audio content rendering device of the rendering equipment.

9. An electronic device for providing an audio content as part of an interactive digital service comprising:
at least one processor; and
at least one non-transitory computer readable medium comprising instructions stored thereon which when executed by the at least one processor configure the electronic device to:
receive an instruction issued by an electronic audio content rendering device of a rendering equipment as part of said interactive digital service;
obtain a next audio content intended to be sent to the electronic audio content rendering device, at least part of said next audio content taking into account at least one context parameter of use of said rendering equipment determined as a function of the instruction and of a set of context parameters of a current audio content prior to said audio next content, the next audio content being associated with another level of information higher or lower than that of the current audio content; and,
transmit data relating to the next audio content to the electronic audio content rendering device of the rendering equipment.

10. A non-transitory, computer-readable medium having stored thereon instructions which, when executed by at least one processor of the electronic audio content rendering device, cause the at least one processor to implement the method of claim 1.

11. A non-transitory computer-readable recording medium having stored thereon instructions which when executed by at least one processor of the electronic audio content provision device, cause the at least one processor to implement the method of claim 8.
